(19) United States
(12) Patent Application Publication
(10) Pub. No.: US 2019/0390628 A1
(43) Pub. Date: Dec. 26, 2019

(54) METHODS AND APPARATUS FOR AN ACTIVELY COOLED CYLINDER BLOCK

(71) Applicant: Leading Edge V-Twin LLC, Scottsdale, AZ (US)

(72) Inventors: Daniel Wilson, Phoenix, AZ (US); Jose R. Elias, Peoria, AZ (US)

(21) Appl. No.: 16/451,294

(22) Filed: Jun. 25, 2019

Related U.S. Application Data
(60) Provisional application No. 62/841,343, filed on May 1, 2019.
(60) Provisional application No. 62/689,397, filed on Jun. 25, 2018.

(51) Int. Cl. F02F 1/06; F02F 1/30; F02B 61/02

(52) U.S. Cl. CPC F02F 1/065; F02B 75/22; F02B 61/02; F02F 1/30

(57) ABSTRACT

An actively cooled air cylinder for a motorcycle engine comprising a cylinder block. The cylinder block may comprise an upper mounting surface, a lower mounding surface, an internal bore extending between the upper mounting surface and the lower mounting surface, a forward facing surface, a rear facing surface, and first and second side surfaces. Each of the surfaces may comprise a plurality of fins and a plurality of cooling channels located between each of the plurality of fins. The cooling channels may comprise a series of peaks and valleys that configured provide turbulent flow of air over the cylinder block when airflow contacts the cylinder.

### CROSS-REFERENCES TO RELATED APPLICATIONS

The present application claims the benefit of U.S. Provisional Application Ser. No. 62/841.343, filed May 1, 2019 and U.S. Provisional Application Ser. No. 62/689,397, filed Jun. 25, 2018 and incorporates the disclosure of each application by reference.

### BACKGROUND OF THE INVENTION

Standard air-cooled engines typically rely on the circulation of air directly over hot parts of the engine to cool them. Many motorcycles use air cooling for the sake of reducing weight and complexity. Typically air cooling of motorcycle engines is facilitated with fins that cover the outer surface of the cylinder, which increase the surface area that air can act upon. Air may be force fed with the use of a fan and shroud to achieve efficient cooling with high volumes of air or simply by natural air flow. The use of natural air flow along with the fins of the cylinder to cool the engine is known as passive cooling. Thus, passive cooling is constrained by the size of the fins on the cylinder and the amount of natural air flow over the fins.

As such, an improved cooled cylinder may be utilized that is actively cooled by turbulent air flow to reduce the heat produced by the engine during use.

### SUMMARY OF THE INVENTION

An actively cooled air cylinder for a motorcycle engine comprising a cylinder block. The cylinder block may comprise an upper mounting surface, a lower mounting surface, an internal bore extending between the upper mounting surface and the lower mounting surface, a forward facing surface, a rear facing surface, and first and second side surfaces. Each of the surfaces may comprise a plurality of fins and a plurality of cooling channels located between each of the plurality of fins. The cooling channels may comprise a series of peaks and valleys that are configured provide turbulent flow of air over the cylinder block when airflow contacts the cylinder.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

The figures described are for illustration purposes only and are not intended to limit the scope of the present disclosure in any way. Various aspects of the present invention may be more fully understood from the detailed description and the accompanying drawing figures, wherein:

FIG. 1 representatively illustrates a perspective view of the bottom, right side and front of an actively cooled cylinder in accordance with various embodiments of the present technology;

FIG. 2 representatively illustrates a bottom view of the actively cooled cylinder in accordance with various embodiments of the present technology;

FIG. 3 representatively illustrates a right side view of the actively cooled cylinder in accordance with various embodiments of the present technology;

FIG. 4 representatively illustrates a front view of the actively cooled cylinder in accordance with various embodiments of the present technology;

FIG. 5 representatively illustrates a top view of the actively cooled cylinder in accordance with various embodiments of the present technology;

FIG. 6 representatively illustrates a right side perspective view of a pair of actively cooled cylinders installed on an engine in accordance with various embodiments of the present technology; and

FIG. 7 representatively illustrates a top, right side perspective view of a pair of actively cooled cylinders installed on an engine in accordance with various embodiments of the present technology;

FIG. 8 representatively illustrates a right side perspective view of a pair of actively cooled cylinders installed on an engine with the rods in place in accordance with various embodiments of the present technology;

FIG. 9 representatively illustrates a left side perspective view of a pair of actively cooled cylinders installed on an engine in accordance with various embodiments of the present technology;

FIG. 10 representatively illustrates a right side perspective view of a pair of actively cooled cylinders installed on an engine with the rods in place in accordance with various embodiments of the present technology;

FIG. 11 representatively illustrates a left side perspective view of a pair of actively cooled cylinders installed on an engine in accordance with various embodiments of the present technology;

FIG. 12 representatively illustrates a right side perspective view of a pair of actively cooled cylinders installed on an engine on a motorcycle in accordance with various embodiments of the present technology;

FIG. 13 representatively illustrates a left side perspective view of a pair of actively cooled cylinders installed on an engine on a motorcycle in accordance with various embodiments of the present technology;

FIG. 14 representatively illustrates a right side perspective view of a pair of actively cooled cylinders installed on an engine with the air filter removed on a motorcycle in accordance with various embodiments of the present technology; and

FIG. 15 representatively illustrates a right side perspective view of a pair of actively cooled cylinders installed on an engine with the air filter installed on a motorcycle in accordance with various embodiments of the present technology.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of materials, connectors, and the like for an actively cooled cylinder for use in with a motorcycle and the system described is merely one exemplary application for the technology.

While exemplary embodiments are described herein in sufficient detail to enable those skilled in the art to practice the invention, it should be understood that other embodiments may be realized and that logical structural, material, and mechanical changes may be made without departing from the spirit and scope of the invention. This disclosure, its aspects and implementations, are not limited to the specific components or assembly procedures disclosed herein. Many additional components and assembly procedures known in the art consistent with the intended apparatus will become apparent for use with implementations of an actively cooled cylinder and accompanying parts. Thus, the following descriptions are not intended as a limitation on the use or applicability of the invention, but instead, are provided merely to enable a full and complete description of exemplary embodiments.

Methods and apparatus for providing cylinder designed to be actively cooled based on the constructed configuration. Various representative implementations of the present technology may be applied to any cooled cylinder.

Standard air-cooled engines typically rely on the circulation of air directly over hot parts of the engine to cool them. Many motorcycles use air cooling for the sake of reducing weight and complexity. Typically air cooling of motorcycle engines is facilitated with fins that cover the outer surface of the cylinder, which increase the surface area that air can act upon. Air may be force fed with the use of a fan and shroud to achieve efficient cooling with high volumes of air or simply by natural air flow. The use of natural air flow along with the fins of the cylinder to cool the engine is known as passive cooling. Thus passive cooling is constrained by the size of the fins on the cylinder and the amount of natural air flow over the fins.

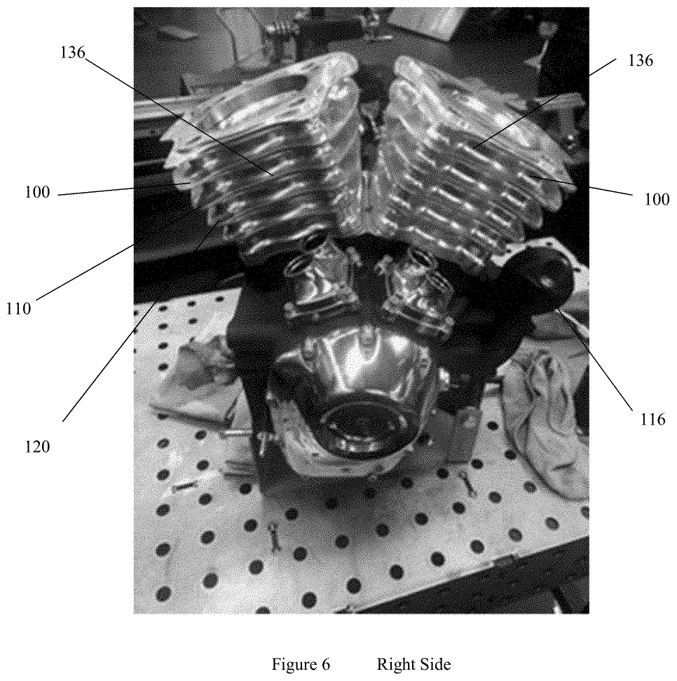

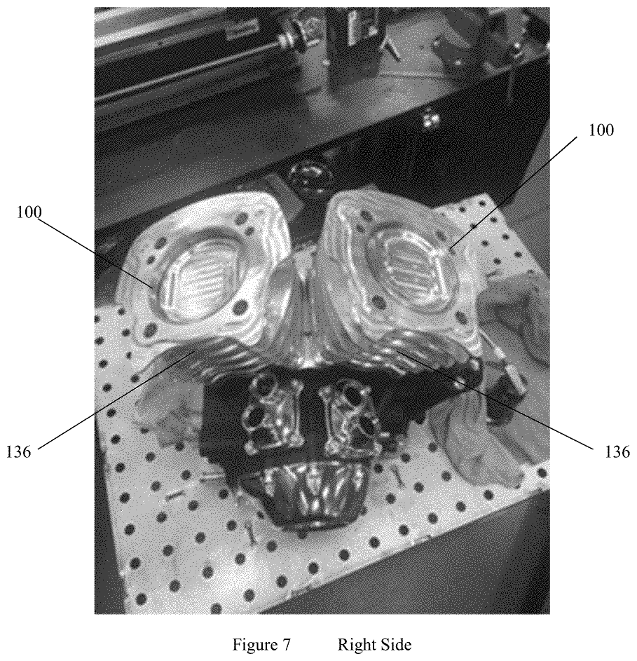

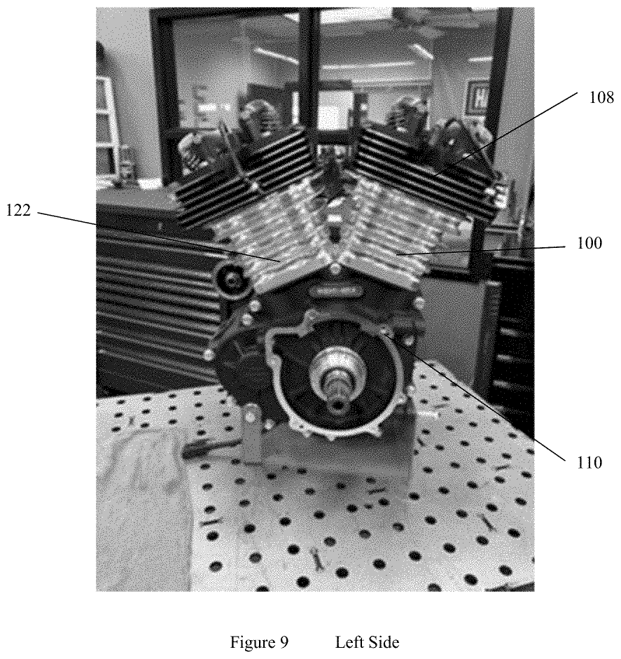

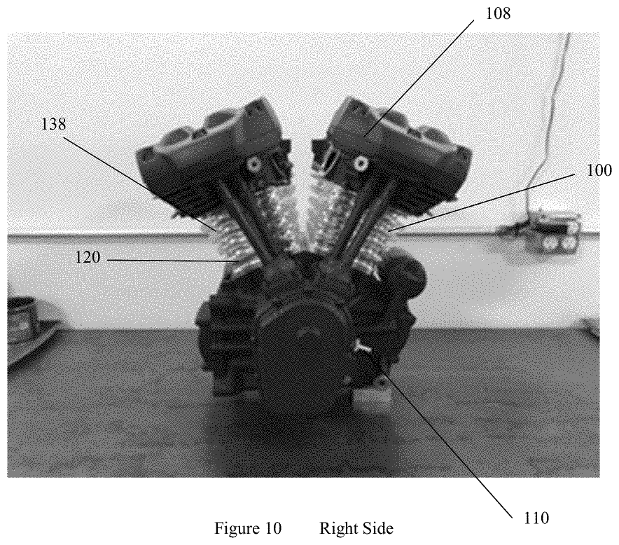

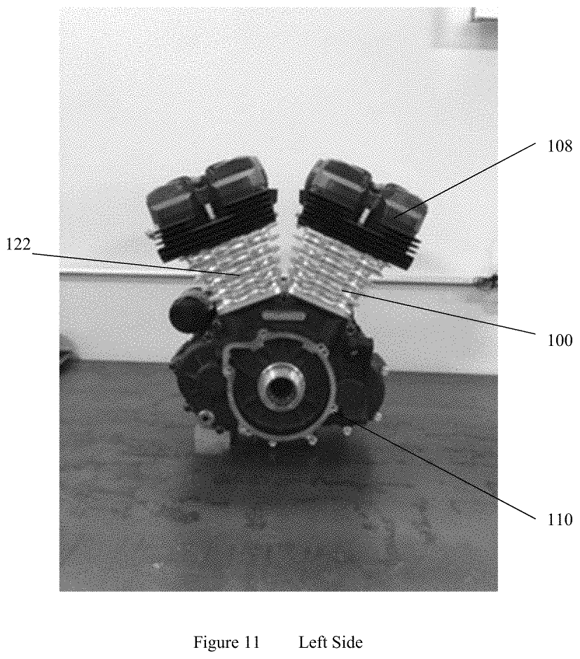

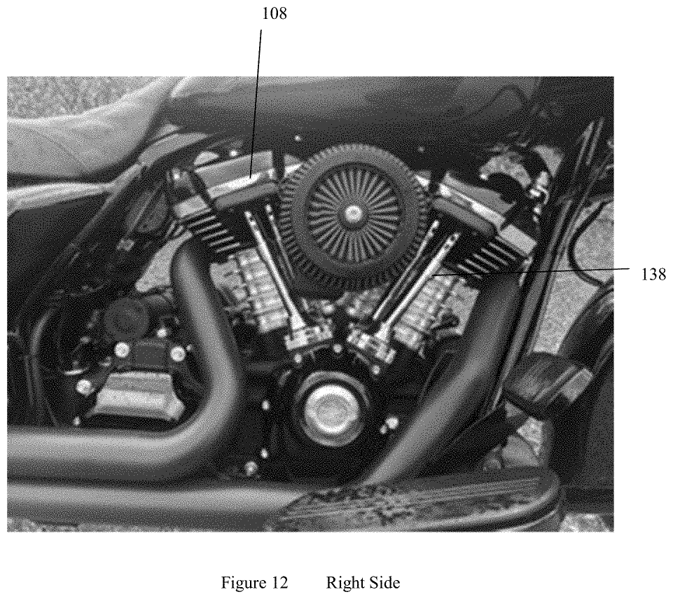

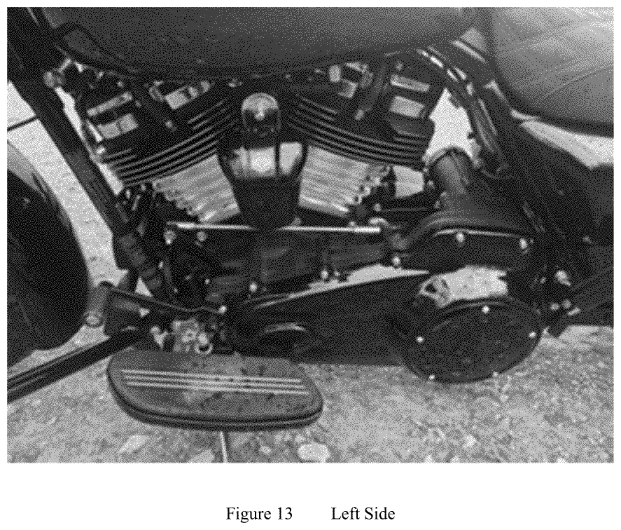

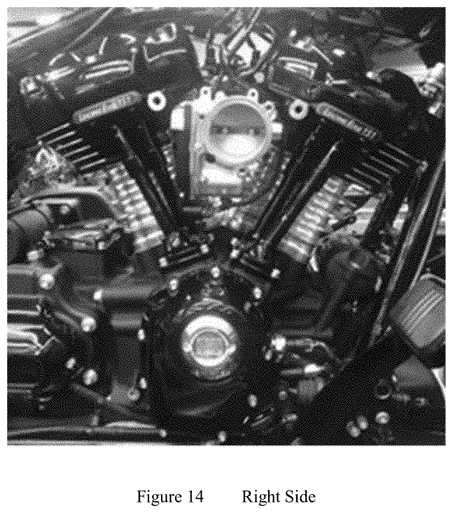

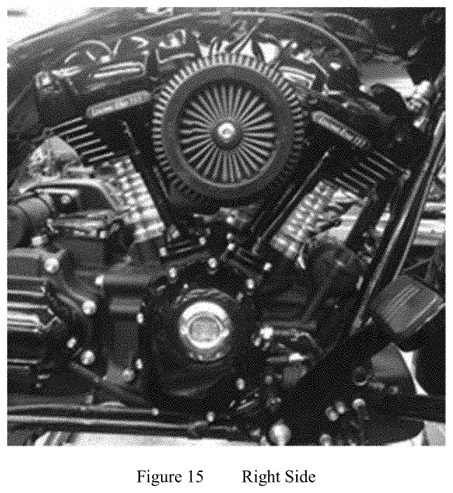

Accordingly a cylinder 100 is contemplated that actively cools the motorcycle engine. The cylinder 100 is interchangeable so as to fit on either side or front and rear part of the engine (See FIGS. 6-15). In one embodiment the cylinder 100 may be sues with a Harley Davidson® Milwaukee-Eight engine.

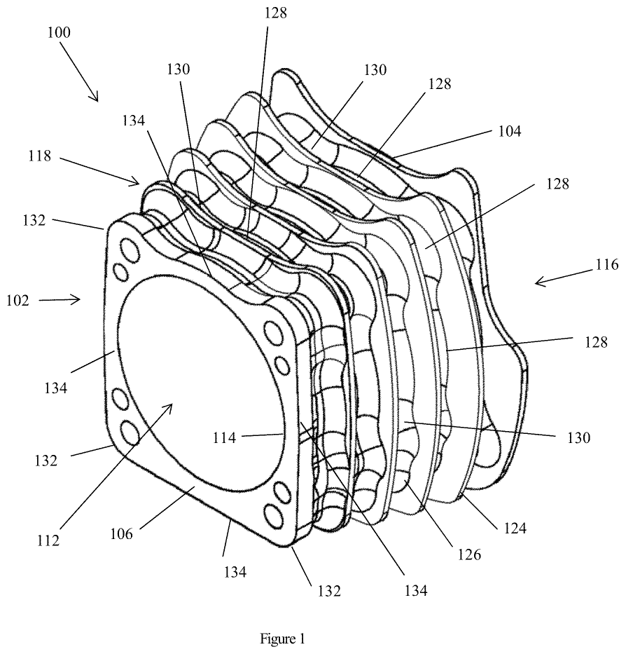

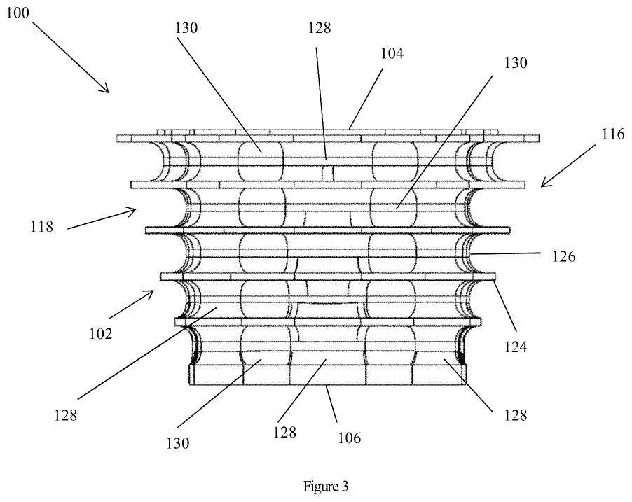

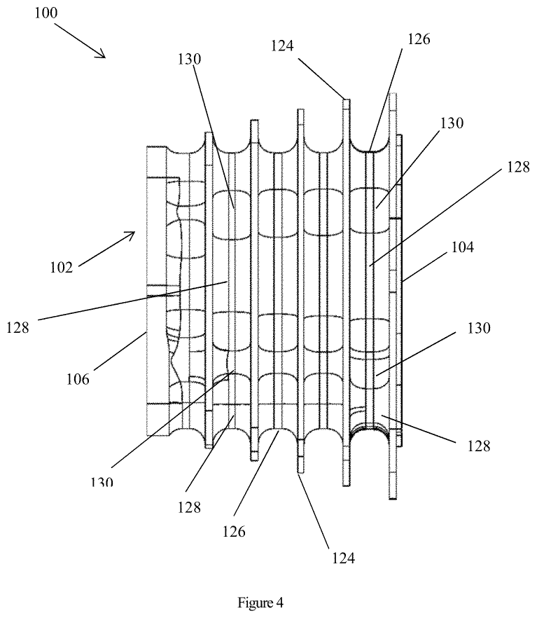

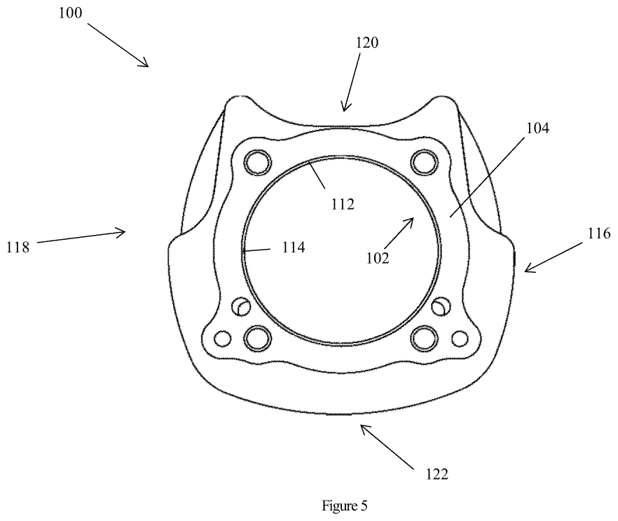

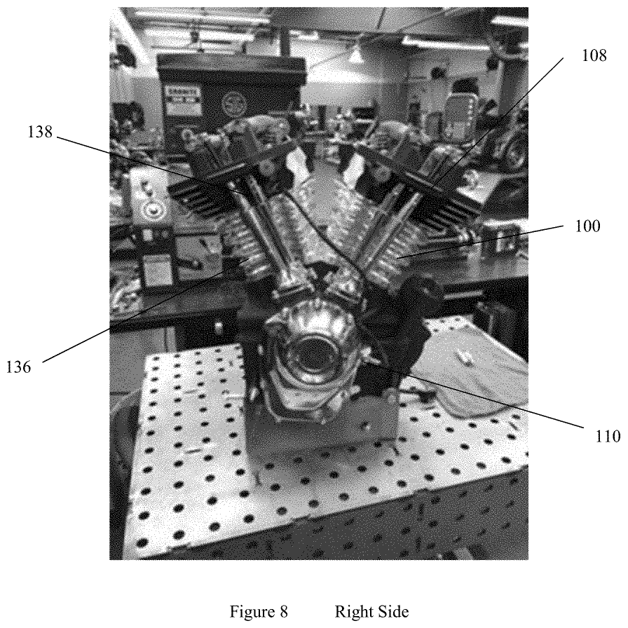

In accordance with various embodiments, referring now to FIGS. 1-5, the cylinder 100 may comprise a cylinder block 102 having an upper and lower mounting surfaces 104, 106. When assembled, valve covers 108 are coupled to top mounting surface 104 and a case 110 is coupled to the lower mounting surface 106 (See FIGS. 8-11). The upper mounting surface 104 contains a 4 hole bolt pattern for coupling the cylinder 100 to the valve covers 108. The lower mounting surface 106 is generally square comprising 4 sides and contains a 4 hole bolt pattern for coupling the cylinder 100 to the engine case 110. The cylinder block 102 may comprise an internal bore 112 which extends from the upper mounting surface 104 to the lower mounting surface 106. The internal bore 112 may comprise a cylinder wall 114 that receives a cylinder sleeve (not shown).

The cylinder block 102 may comprise a forward facing surface 116, a rear facing surface 118, and first and second side surfaces 120, 122. In one embodiment, the forward facing surface 116 and the rear facing surface 118 may have substantially the same shape and configuration or have mirroring dimensions.

Each of the surfaces may comprise a plurality of fins 124 and cooling channels 126, which are located between the upper and lower mounting surfaces 104, 106. The fins 124 may extend outwardly from the cylinder block 102 and provide cooling to the cylinder 100. In one embodiment, the fins 124 extend from the cylinder block 102 at a generally 90 degree relative to the axis of the internal bore 112. The length of the fins may increase from the lower mounting surface 106 to the upper mounting surface 104 of the cylinder 100.

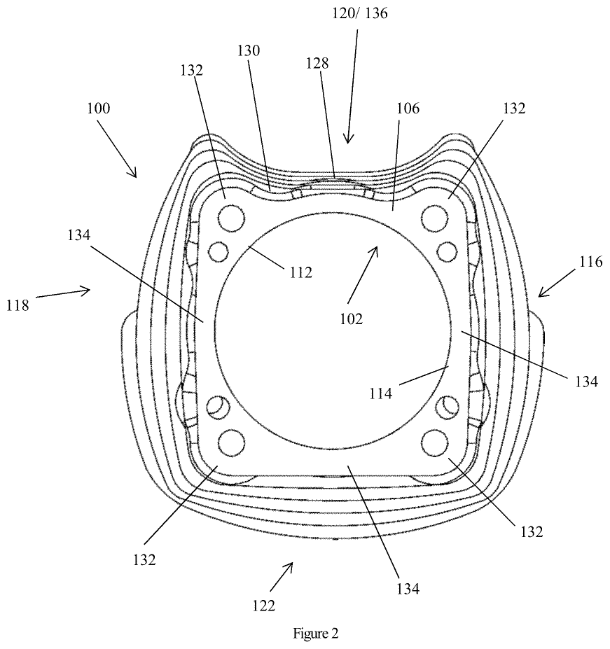

The cooling channels 126 are located between each of the fins 124. The cooling channels may comprise a series of peaks 128 and valleys 130 that are configured provide turbulent flow of air over the cylinder 100 when airflow contacts the cylinder 100. Standard cooling channels on cylinders typically do not contain peaks and valleys, rather they are generally flat between the fins. As shown in FIGS. 1 and 2, the lower mounting surface 106 is generally square comprising 4 sides and a 4 hole bolt pattern located towards the corners of the square for coupling the cylinder 100 to the engine case 110. The sides each contain a pair of ends 132 and a midpoint 134 between the ends 132. In one embodiment, the peaks 128 are located at the ends 132 and the midpoints 134 and the valleys 130 are located between each end 132 and midpoint 134. The orientation of the peaks 128 and valleys 130 within the cooling channels 126 provides turbulent air flow within cooing channels 126. As is understood by one of ordinary skill in the art, turbulence or turbulent flow is fluid motion characterized by chaotic changes in pressure and flow velocity. It is in contrast to a laminar flow, which occurs when a fluid flows in parallel layers, with no disruption between those layers. In one embodiment, the peaks 128 and valleys 130 are located within each cooling channel 126 and extend from the lower mounting surface 106 to the upper mounting surface 104.

The turbulent air flow over the cylinder 100 increases the heat transfer rate across the external surfaces of the cylinder 100 thereby allowing the cylinder 100 to be actively cooled. Turbulent air flow provides constant movement of air over the surface of the cooling channels 126 to cool the cylinder 100.

The fins 124 may be configured in various heights to adjust a depth of the cooling channels 126 and/or to accommodate the various engine parts and space restriction when the cylinders 100 are installed on the engine. For example, as shown in FIGS. 2, 6-8, 12, 14, and 15 the right side fins 136 on the first side surface 120 can be shaped to allow the rods 138 to be installed. As such, the cylinders 100 may be configurable to virtually any engine type and configuration.

In various embodiments the cylinder 100 may be constructed from any suitable material, such as cast iron, aluminum, and the like. In one embodiment, the cylinder 100 may be constructed from 6061 billet aluminum. The 6061 billet aluminum may be Computer Numerical Control “CNC” machined to create the cylinder 100.

In the foregoing description, the technology has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

1. An actively cooled air cylinder for a motorcycle engine comprising:
a cylinder block comprising:
an upper mounting surface,
a lower mounting surface;
an internal bore extending between the upper mounting surface and the lower mounting surface;
a forward facing surface;
a rear facing surface;
first and second facing side surfaces; and
each facing surface comprising a plurality of fins and a plurality of cooling channels located between each of the plurality of fins;
wherein the cooling channels comprise a series of peaks and valleys.

2. The actively cooled air cylinder of claim 1, wherein the upper and lower mounting surfaces each comprise a 4 hole bolt pattern, where each bolt hole is located on a corner of the upper and lower mounting surfaces.

3. The actively cooled air cylinder of claim 2, wherein the peak and valleys extend from the lower mounting surface to the upper mounting surface.

4. The actively cooled air cylinder of claim 3, wherein the peaks of the cooling channels are located at the corners of the upper and lower mounting surfaces.

5. The actively cooled air cylinder of claim 4, wherein the peaks of the cooling channels are located at a midpoint between the corners of the upper and lower mounting surfaces.

6. The actively cooled air cylinder of claim 5, wherein the valleys of the cooling channels are located between the adjacent peaks at each midpoint and corner of the upper and lower mounting surfaces.

7. The actively cooled air cylinder of claim 1, wherein the fins extend outwardly from the cylinder block.

8. The actively cooled air cylinder of claim 7, wherein the fins extend outwardly from the cylinder block at generally a 90 degree angle.

9. The actively cooled air cylinder of claim 8, wherein the fins decrease in length from the lower mounting surface to the upper mounting surface.

10. The actively cooled air cylinder of claim 1, wherein the peaks and valleys of the cooling channels are configured provide turbulent flow of air over the cylinder block when airflow contacts the cylinder.

11. The actively cooled air cylinder of claim 10, turbulent flow of air over the cylinder block actively cools the engine.

12. The actively cooled air cylinder of claim 1, wherein the cylinder block is constructed of 6061 billet aluminum.

13. The actively cooled air cylinder of claim 12, wherein the 6061 billet aluminum cylinder block is CNC machined.

14. The actively cooled air cylinder of claim 3, wherein the peaks of the cooling channels may comprise corner peaks located at the corners of the upper and lower mounting surfaces.

15. The actively cooled air cylinder of claim 4, wherein the peaks of the cooling channels may comprise midpoint peaks located at a midpoint between the corners of the upper and lower mounting surfaces.

16. The actively cooled air cylinder of claim 5, wherein the valleys of the cooling channels are located between the corner peaks and midpoint peaks.

17. An actively cooled air cylinder for a motorcycle engine comprising:
a cylinder block comprising:
an upper mounting surface,
a lower mounting surface;
an internal bore extending between the upper mounting surface and the lower mounting surface;
a forward facing surface;
a rear facing surface;
first and second facing side surfaces; and
each facing surface comprising a plurality of fins and a plurality of cooling channels located between each of the plurality of fins;
wherein the cooling channels comprise:
corner peaks located at the corners of the upper and lower mounting surfaces,
midpoint peaks located at a midpoint between the corners of the upper and lower mounting surfaces, and
and valleys located between the corner peaks and midpoint peaks.

18. The actively cooled air cylinder of claim 17, wherein the peaks and valleys of the cooling channels are configured provide turbulent flow of air over the cylinder block when airflow contacts the cylinder.

19. The actively cooled air cylinder of claim 18, turbulent flow of air over the cylinder block actively cools the engine.

20. The actively cooled air cylinder of claim 1, wherein the cylinder block is constructed of 6061 billet aluminum.
